(19) United States
(12) Patent Application Publication
(10) Pub. No.: US 2022/0179399 A1
(43) Pub. Date: Jun. 9, 2022

(54) Method and System for Flare Stack Monitoring and Optimization

(71) Applicant: Maillance SAS, Paris (FR)

(72) Inventors: Yasin Hajizadeh, Katy, TX (US); Jean-Paul Dessap, Paris (FR); Charles-Edouard Cohen, Neuilly-sur-Seine (FR)

(21) Appl. No.: 17/369,934

(22) Filed: Jul. 7, 2021

Related U.S. Application Data
(60) Provisional application No. 63/048,905, filed on Jul. 7, 2020.

(51) Int. Cl. G05B 19/4155

(52) U.S. Cl. CPC G05B 19/4155; G05B 2219/41108

(57) ABSTRACT

An integrated and comprehensive method and system is disclosed for measuring and real-time monitoring of gas flare and using that information to improve and/or optimize oil and gas production and/or flare operations. A first embodiment of the invention comprises a camera or any other visual recognition and recording system coupled with an image and video analytics/machine learning module to measure the flare and identify gas components or flow properties. A second embodiment of the invention is directed towards an intelligent optimization method and system that uses the flare and gas information and suggest a set of optimal production values to optimize flaring and reduce environmental impact of it.

### CROSS-REFERENCE TO RELATED APPLICATIONS

This application claims the benefit of U.S. provisional application No. 63/048,905 entitled Method and System for Flare Stack Monitoring and Optimization and filed 7 Jul. 2020 (docket no. 20-1081-PRO), which is hereby incorporated by reference as though fully set forth herein.

### FIELD

This disclosure is related to aspect of computer assisted methods, workflows, systems and apparatuses for recognition and classification of gas flare stack and its components and flow properties; and prediction and optimization of underlying hydrocarbon production systems connected to the flare stack.

### BACKGROUND

Flaring is the controlled combustion of natural gas for operational, economical and safety reasons. The process can happen during upstream operations such as drilling and well testing; or later in the lifecycle of an oil and gas project in downstream refining and processing operations. For instance, oil and gas drillers may flare gas influx during drilling operations by diverting and disposing of gas using a flare stack.

Furthermore, several decision-making factors in flare optimization may compete against each other. As an example, a decision that optimizes the economics of the project, may compromise the longevity aspect of the design. Selecting the right combination of design parameters can be an extremely challenging task for the decision makers. Real-life optimization problems deal with multiple objectives which are often conflicting. The common practice to tackle optimization problems is to use a priori methods. A priori methods focus on relative importance of objectives and user's input to specify a preference before initializing the optimization algorithm. The dominating approach in this category is the weighted sum method in which objective functions are scalarized to form a single objective function using weight factors. The main drawbacks of this approach include the cumbersome task of determining weight factors, dependence of weights on the scale of individual objective functions, inability to handle problems with a non-convex Pareto front (Das and Dennis, 1997) and the need to try multiple weight factors in dealing with convex Pareto fronts. Decision makers may, in fact, miss solutions that would have addressed the conflicting nature of business objectives. Therefore, existing solutions to flaring management that use a single model and objective function without considering inherent competing objectives in them are bound to fail in addressing real-world challenges.

US Pat. Application No. US2011/0207064 A1, published Aug. 5, 2011 by Salani et al., proposes a system to monitor the flare stack to check if they are lit; and ignite the pilot burner automatically if the flame sensor does not detect a flame. The system can also use electrochemical cell or infrared sensors to detect proportions of oxygen, carbon monoxide and/or carbon dioxide in the sample in order to reignite the pilot if these values differ from historical values or a predetermined value. For example, presence of CO in proportions greater than in free air is an indication of combustion. This method does not involve detecting proportions of hydrocarbons in the feed stream. Additionally, the objective is a binary classification (flare lit/not lit) and no attempt is made to correlate sensor readings with the hydrocarbon proportions of the flare feed and to adjust oil and gas production operations to optimize flaring.

U.S. Pat. No. 9,258,495 B2, granted on Feb. 9, 2016 by Zeng et al., discloses a multi-spectral infrared imaging system for flare combustion efficiency monitoring. The system includes four spectral bands (one for a hydrocarbon group (fuel), one for carbon dioxide, one for carbon monoxide, and one for background reference. The system, using at least three spatially and temporally intensities from an imaging unit, estimates the combustion efficiency of the flare using a weighted carbon number (n). The method solely focuses on spectral readings and doesn't consider flare shape and other properties of it. The drawback of this method is that it acts as an informational system by only providing feedback to operators. It is then their job to adjust operational conditions of the flare to optimize it. Furthermore, the loop is not complete as there is no connection with the upstream feed being received in the flare. Therefore, there is no chance of adjusting the conditions and operational parameters of production or processing facilities.

U.S. Pat. Application No. US 2018/0195889 A1 B1, published Jul. 12, 2018 by Skelding et al., proposes a method and system to measure gas flow metering in flares. This is achieved by using ultrasonic transducers in upstream and downstream; and measuring the transit time between transducers to calculate velocity of gas. The drawback of this method is that it requires installing transducers in a peripheral wall of a conduit at an angle to the flow of gas. The method also requires expert-level persons to operate it.

Elvidge et al. (2016) describes a method for global survey of flaring activity using satellite data collected by NASA and NOAA's Visible Infrared Imaging Radiometer Suite (VIIRS). This method only provides a global map with country and region-based information. Therefore, it cannot be used for monitoring and optimization of individual flare stacks and facilities.

Gurajapu et al. (2020) in US Patent Application US2020/0387120 describe an integrated method and system for connected advanced flare analytics. While they consider categories of smoke, flame and steam, their approach does not consider the composition of the gas burned as one of the outputs of the machine learning algorithm. Additionally, the control system proposed does not adjust upstream or midstream oil and gas exploration and production activities. The proposed control mechanism only acts in the plant level, ignoring the complexities of delivering the hydrocarbon from subsurface reservoirs to such plants.

As such, there remains a need for a system and method capable of assisting users with monitoring and automated optimization of flaring operations and adjusting upstream oil and gas production accordingly.

### SUMMARY

In one embodiment, a method for adjusting a composition of an oil and gas flow is provided. In this embodiment, the method includes capturing at least one of image and video data of a flare via a camera. The method also includes analyzing at least one of image and video data using a processor to determine properties of gas in the flare; and controlling at least one of an upstream or midstream operation on the oil and gas flow to modify the composition of the oil and gas flow based on the properties in the flare.

In another embodiment, a system for adjusting a composition of an oil and gas flow is provided. In this embodiment, the system includes a camera adapted to capture at least one of image and video data of a flare. A processor is in communication with the camera and is adapted to receive the at least one of image and video data and analyze analyzing the at least one of image and video data to determine properties of gas in the flare. A controller is in communication with the processor and is adapted to control at least one of an upstream or midstream operation on the oil and gas flow to modify the composition of the oil and gas flow based on the properties in the flare.

Accordingly, this document discloses a system and method for automated monitoring of flare stacks and optimization of flaring and production operations in order to accomplish certain objectives, such as environmental impact or operational cost. A multimedia gathering system is used where a camera is directed towards a flare. In one embodiment, image/video from a flare is analyzed and used in a machine learning predictive framework to identify hydrocarbon composition of gas automatically. Upon identification of composition, the information is correlated with available upstream production data from wells in the field.

A further object of the invention is a novel and efficient system and method for multi-objective improvement and/or optimization of flaring operations and processes by adjusting production of oil and gas. An optimization module modifies the decision variables in an iterative fashion by selecting multiple values from a pre-defined range and distribution. In order to evaluate entries, multiple objective functions are defined and calculated using models and mathematical relationships that can predict outcomes of each scenario entries such as costs, revenue, risks, and environmental impacts. To calculate the objective functions, users can select from a list of functions provided by the software or define their own objective functions and evaluation criteria.

This summary is provided to introduce a selection of concepts in a simplified form that are further described herein. This summary is not indented to identify key or essential features of the claimed subject matter, nor is it intended to be used as an aid in determining the scope of the claimed subject matter.

### BRIEF DESCRIPTION OF THE DRAWINGS

A more complete appreciation of the invention and many of the attendant advantages thereof will be readily obtained as the same becomes better understood by reference to the following detailed descriptions when considered in connection with the accompanying drawings; it being understood that the drawings contained herein are not necessarily drawn to scale and that the accompanying drawings provide illustrative implementations and are not meant to limit the scope of the various technologies described herein; wherein:

FIG. 1 is a schematic diagram showing an embodiment of a camera system used in prediction of gas composition coming from oil and gas production via separation facilities.

FIG. 2 is a block diagram showing an embodiment of a system for monitoring and optimization of a flare system and its various components.

FIG. 3 is a flow chart showing an embodiment of an estimation and prediction module for prediction of gas composition.

FIG. 4 is a schematic diagram showing an embodiment of exemplary mapping between decision variable space and objective function space.

FIG. 5A is a flow chart showing an embodiment of a multi-objective optimization module adapted to improve and/or optimize flaring and production operational decision variables.

FIG. 5B is a is a graph showing one example of a Pareto multi-objective analysis in which the objectives include simultaneously reducing/minimizing flaring and increasing/maximizing oil production.

FIG. 6 is a block diagram showing an embodiment of an architecture of a system adapted to run a flare monitoring and optimization system as a service on the cloud or on premise.

FIG. 7 is a block diagram showing a coupling of an output of a results module with a second machine learning based optimization module to change operating parameters of well equipment to fine-tune the oil and gas production to reduce and/or minimize flaring and/or increase combustion efficiency of the flare.

FIG. 8 is a conceptual block diagram 800 illustrating another embodiment of a flare monitoring and optimization system in which a machine learning analytics system is provided to control one or more operation of a pipeline based on one or more output of the monitoring system.

FIG. 9 is a schematic diagram showing an example embodiment of a machine learning analytics system 900, such as described with reference to FIG. 8.

FIG. 10 is a schematic diagram of an embodiment of a Mask R-CNN framework for instance segmentation.

FIG. 11 is a schematic diagram of the Mask R-CNN framework shown in FIG. 10.

FIG. 12 is a block diagram showing an embodiment of an upstream control system.

FIG. 13 is a block diagram showing an embodiment of a midstream control system.

FIG. 14 is a visual depiction of an embodiment of a sample of separator pressure optimization.

FIG. 15 shows an embodiment of a user interface showing user's interaction with the system and a mechanism to specify input parameters of the optimization, their range, and objective function/outputs.

FIG. 16 is a block diagram illustrating illustrates an exemplary system useful in implementations of the described technology.

### DETAILED DESCRIPTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding of the claims. However, it will be apparent to one of ordinary skill in the art that the claims may be practiced without these specific details. In other instances, well-known features have not been described in detail to avoid unnecessarily complicating the description. While the disclosure is a complete description of the preferred embodiments, it is possible to use various alternatives, modifications and equivalents. These modifications of the embodiments, as well as alternatives embodiments of the invention will become apparent to persons skilled in the art upon reference to the description of the invention. Therefore, the scope of the present invention should be determined not with reference to the description but should, instead, be determined with reference to the appended claims, along with their full scope of equivalents. Any feature described herein, whether preferred or not, may be combined with any other feature described herein, whether preferred or not. In the claims that follow, the indefinite article “A” or “An” refers to a quantity of one or more of the item following the article, except where expressed otherwise. The appended claims are not to be interpreted as including means-plus-function limitations, unless such a limitation is explicitly recited in a given claim using the phrase “means for”.

Throughout the application, ordinal numbers st, second, third, etc.) may be used as an adjective for an element (i.e., any noun in the application). The use of ordinal numbers is not to imply or create any particular ordering of the elements nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

### Input

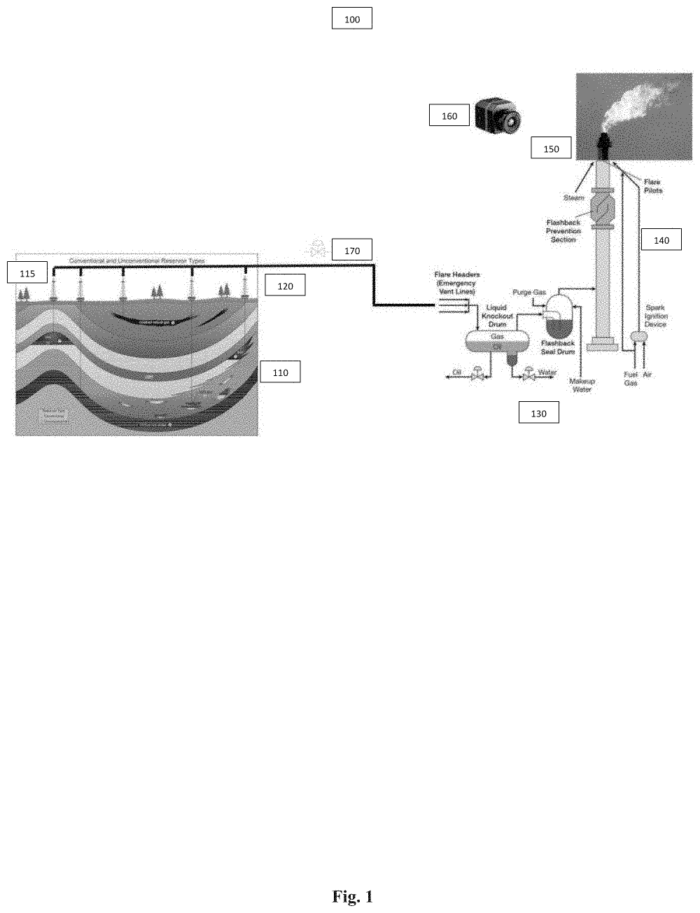

FIG. 1 is a conceptual block diagram 100 illustrating an embodiment of a flare monitoring and optimization system. In FIG. 1, oil and gas is produced from subsurface reservoirs 110 through wells 115 and is transported using pipelines 120 to a surface treatment facility 130 that separates a multiphase flow (e.g. oil, gas, water). The excess gas from surface treatment facilities then might be sent to a flaring stack 140 for burning. In one embodiment, a camera 160 is placed to view the flare 150 and provide continuous image and video of flare as an input to the system. In another embodiment, a user may take a photo and/or video using a mobile phone, tablet, and a similar apparatus. Multimedia capture system is collectively known as input module where images and/or videos captured by camera are received and processed for storage and prediction purposes. In yet another embodiment, upon recognition of gas composition based on multimedia analysis and machine learning, a new fluid flowrate to optimize flaring operation is identified and transmitted to one or more flow control valves 170 to adjust the rate to a newly determined value.

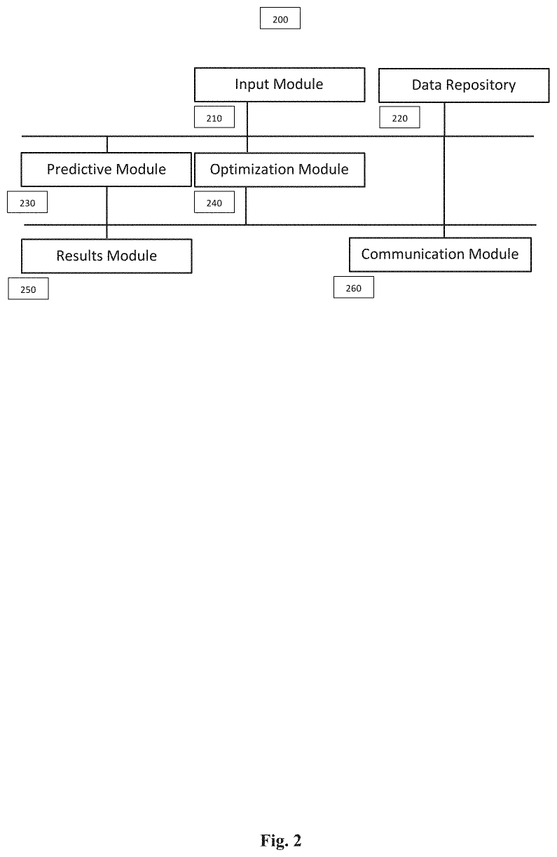

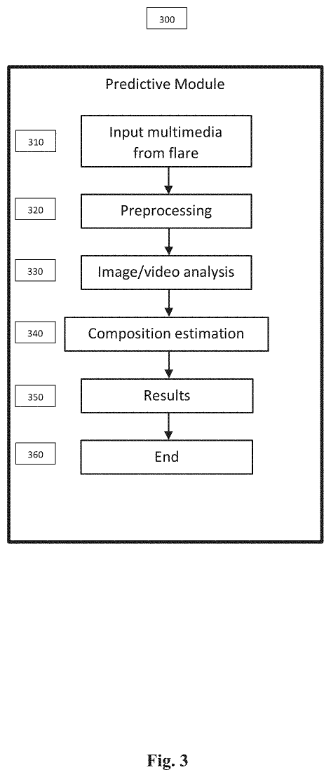

FIG. 2 is a block diagram showing an embodiment of a flare management and optimization system that has several modules including an input module 210, data repository 220, predictive module 230, optimization module 240, results module 250 and communication and sharing module 260. The input module is adapted to receive a media input from the visual recognition and recording system, such as but not limited to a hyper-spectral or multi-spectral camera. The media input may comprise one or more video and/or image input signal from a multimedia capture system, such as described with reference to FIG. 1. The media input may be processed for analysis and/or storage as described in more detail with reference to FIG. 3.

Data repository module 220 stores multimedia received in the input module 210. It may also compare the feed from input module 210 with other existing internal or external databases (e.g., a library). The purpose of this step is to locate any image/video and associated information that might be relevant to flare image/video inputs received by the system; so that a clustering algorithm can identify similarities not only between new flare image/video entries but also with any existing internal or external information. In one embodiment, an algorithm for recognition of images and video is a deep Convolutional Neural Networks (CNN) algorithm. Other algorithms that may be used include, but are not limited to, Mask R-CNN, and View-GCN. The repository module, upon having right privileges, can access existing internal databases (e.g. previous flare information and multimedia data, best practices, etc.) and/or external databases. External databases can be divided into two groups: open databases such as Google's search engine; and closed databases where special permissions or payments are required to gain access (e.g. scientific databases with paid membership).

### Estimation and Prediction

The predictive module 230 uses images and/or videos received in input module 210 and data repository 220 to train a machine learning model to predict gas composition being burnt in flare and associated flow regime and properties, such as flow rate. FIG. 3 is a flow chart showing an embodiment of an estimation and prediction module 230 for prediction of gas composition. In this embodiment, the prediction module 230 receives one or more media input from a visual recognition and recording system, such as a camera. The media input, for example, may comprise one or more video and/or image input signals captured from a flare in operation 310. The input signal(s) are preprocessed in operation 320. Preprocessing refers to any transformation(s) on the raw data that is performed before it is subjected to machine learning and/or deep learning. It may include but is not limited to sampling and extracting certain frames from captured video, resizing the image, normalization, and removing noise from image data. For example, Gaussian blur can be used to denoise images. Analysis of the input signal(s) is performed in operation 330. This analysis, for example, may comprise video and/or image analysis of the input signal(s). A composition estimation is performed in operation 340. For example, the neural network may estimate values such as carbon to hydrogen molar ration (CHR) and carbon number (CN) as its output based on the image or video used as an input in the inference stage after training. A neural network can be trained on prior images/videos of the flare with known CHR and CN values of the feed. CHR is the atomic ration of carbon to hydrogen, while carbon number is the molar average of carbon atoms in flare's fuel stream. Results of the estimation are determined in operation 350. The process ends at operation 360 and the results are provided to a results module as shown in FIG. 2.

Once the flare composition is determined and presented in the results module, it can be used to modify and/or optimize upstream and midstream operations to modify and/or optimize the flaring operations. In one example, production wells may be equipped with an electric submersible pump (ESP). An ESP is a type of pump that is enclosed in a protective housing that enables it to be submerged in the fluid that will be pumped. An electric motor drives the pump and can be controlled with a variable frequency drive (VFD) module. The higher VFD values result in faster motor rotates. One example of using the composition estimation is to control the ESP by adjusting the VFD values of the pump. To achieve this objective, the results module (250) is coupled with a secondary machine-learning based optimization module. This digital twin module uses the relationship between input parameters such as geological structure of the reservoir, location and pattern of production and injection wells, rock and fluid properties of reservoir, and pump parameters including VFD values to estimate the oil and gas production as its output parameter. Therefore, once a model is trained using historical field data, it can be used to estimate the amount of oil and gas that can be produced at any given VFD setting. Once the gas composition is estimated, it is used by the ML Adjuster/Optimizer (XXX) to find the best VFD value, and corresponding rotation speed so that an increased and/or optimal amount of oil is produced from a well. This increased and/or optimal oil production helps to improve and/or optimize the flaring operations in such a way that flaring is reduced and/or minimized and/or combustion efficiency is increased.

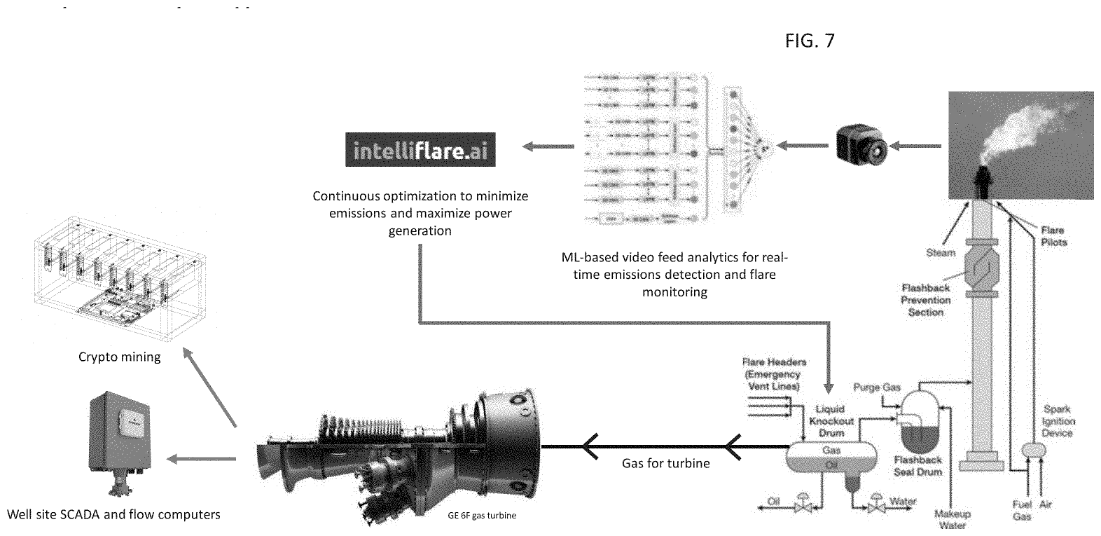

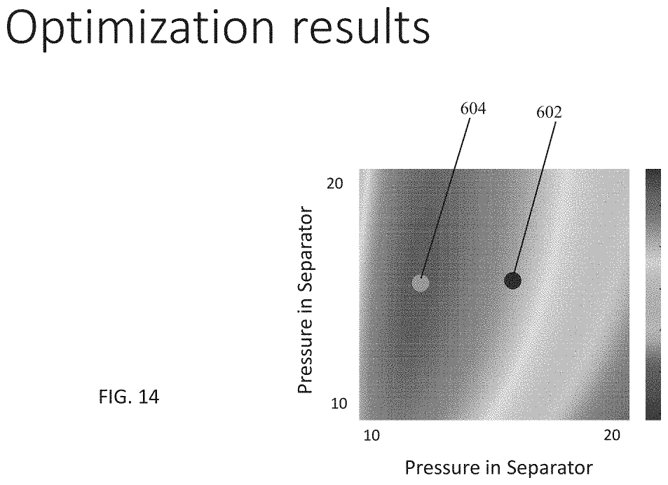

In yet another example, as shown in FIG. 7, the output of composition estimation can be used to control the midstream operations. For example, the system can adjust a multi-stage separator's pressure (130) in an adaptive fashion in real-time to adjust and/or optimize the flaring gas amount. Separators work on the principle that oil, water, and gas have different densities and therefore these fluids can be separated into gaseous and liquid components. The pressure is controlled using valves located on the outlet gas flow. For example, the reservoir fluid can be flashed in an initial separator and then a second flash can be performed on the liquid from the first separator. Oil recovery is impacted by the separator pressure and reservoir fluid composition. A machine learning model, such as but not limited to an artificial neural network is used in one embodiment to model the relationship between pressure, molar volume, and temperature for pure components and mixtures. Then, an adjuster/optimization routine is coupled with the ML digital twin model to select a separator pressure that increases and/or maximizes oil production, and/or decreases and/or minimizes gas that will be flared, and/or improve and/or optimize its composition for combustion. A sample of separator pressure optimization results is presented in FIG. 14 where a first dot 602 represents the existing separator pressures and the second dot 604 indicated the calculated optimal pressures.

Instead of flaring the gas, the gas output of a separator can also be used to in a gas turbine to generate power that can be used power wellsite equipment such as computers and pumps. In this case, the optimization in addition to using separate pressures as an input parameter in the optimization routine, turbine parameters such as compressor settings and operational temperatures can be included as additional input parameters. The objective function that will be optimized in this case can be maximization of power output of the turbine and/or efficiency and/or minimization of downtime for maintenance.

### Multi-Objective Optimization of Decision Variables

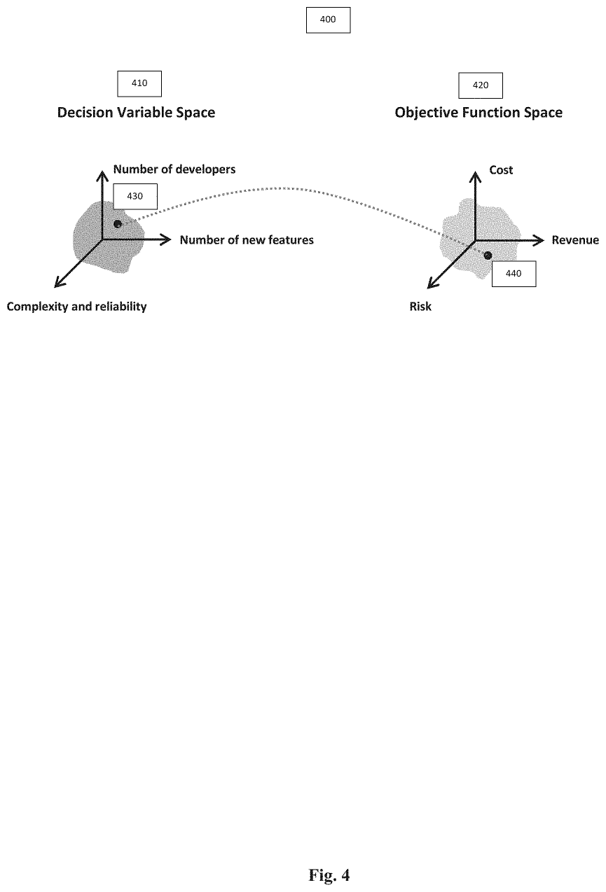

Real-life optimization problems deal with multiple objectives which are often conflicting. Although the terms “optimization,” “optimize” and the like are used herein, one of ordinary skill in the art would readily appreciate from the disclosure provided that improvements, while not necessarily full optimizations, are also contemplated and are included wherever a term such as “optimization” are used. The multi-objective optimization field is concerned with finding optimal solutions in the presence of more than one objective or goal in the decision space. The optimality can be a minimized value if a cost function is considered or a maximized value if the objective function is defined as a utility function. As shown in FIG. 4, there is a mapping between decision variable space or search variables 410 and objective function or solutions space 420 in a multi-objective setup where a solution in the decision variable space 430 has a corresponding multi-dimensional objective function value 440. In a general form, the problem can be described using the following equation.

$$\begin{matrix}Maximize / Minimize {f}_{m} ( x ) , & m = 1 , 2 , … , M \\ Subject to {g}_{j} ( x ) \geq 0 , & j = 1 , 2 , … , J \\ {h}_{k} ( x ) = 0 , & k = 1 , 2 , … , K\end{matrix} \}$$

where x is a decision vector of n variables: x=(x₁, x₂, . . . , xₙ) and the number of objective functions in the problem is denoted with M. n the problem which can be minimized or maximized: f(x)=(f₁ (x), f₂ (x), . . . , f_{M} (x)). The problem can come with a set of constraints (gⱼ (x) and hₖ (x)) that determine the set of feasible solutions.

In a multi-objective optimization context, the aim is not to find a single solution but to explore a set of compromises among the objectives. Therefore, it is possible to define a dominance concept referred to as Edgeworth-Pareto optimality or more commonly known as Pareto optimality. The concept states that if there is an alternative solution (A) that is at least equal to (B) in terms of all objective functions, and if (A) is strictly better than (B) for at least one of the objective functions, then A dominates B (A [symbol] B) The following equation shows the Pareto optimality concept.

1) fₘ(A) [symbol] fₘ(B) for all m = 1,2, ..., M (A is no worse than B for all
objectives)
AND
2) fₘ(A) [symbol] fₘ(B) for at least one m = 1,2, ..., M (A is better than B for
at least one objective)

A solution is called Pareto optimal if there is no feasible solution that can optimize an objective without causing a simultaneous degradation in at least another objective. Two main objectives can be followed in solving any multi-objective optimization; (1) obtain solutions as close as possible to the true Pareto front and (2) these solutions are as diverse as possible.

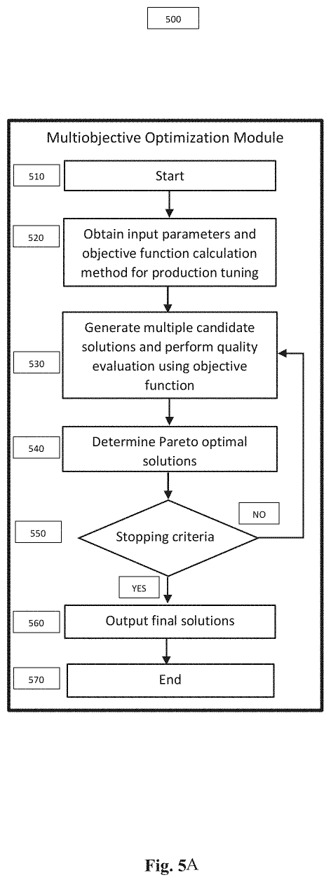

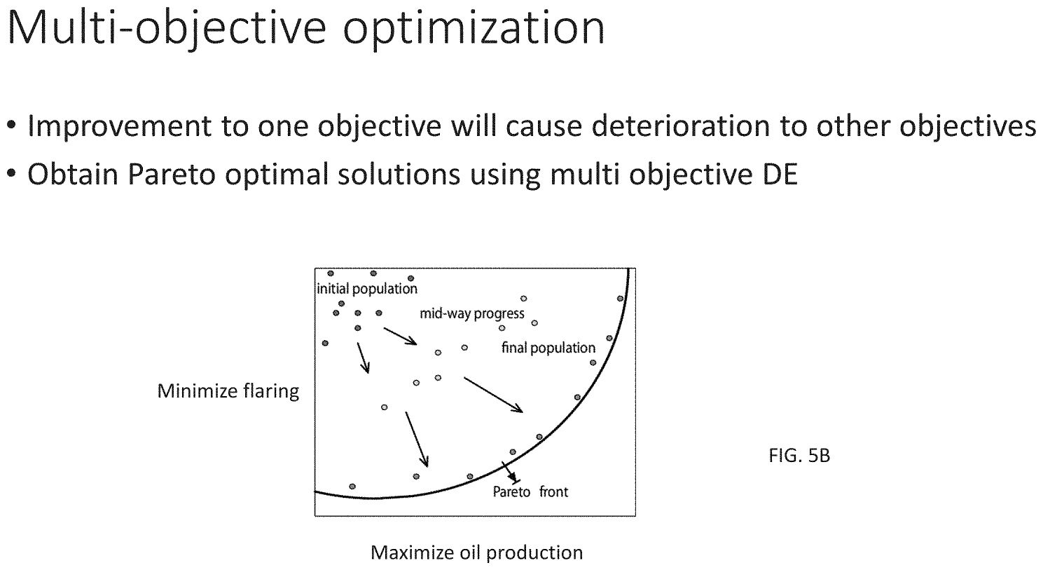

FIG. 5A shows an embodiment of a workflow 500 used to perform multi-objective optimization on decision variables of production and flaring systems. The system starts 510 by obtaining the input parameters of production and flare systems and corresponding objective function calculation method 520. The multi-objective optimization algorithm generates multiple candidate solutions in each iteration. Each proposed solution's fitness and quality are evaluated using the objective functions. Based on fitness scores, the Pareto optimal solutions in each generation are recorded 540. In the next stage, stopping criteria for the optimization are checked 550. The stopping criteria can be the maximum number of iterations, a threshold for objective function values, a predetermined improvement of objective function values in two consecutive iterations or a combination of these criteria. If the stopping criteria are met, the system outputs the final solutions and corresponding Pareto front 560 and ends the workflow 570. If the stopping criteria are not met, the system can go back to step 530 and generate the next set of solutions.

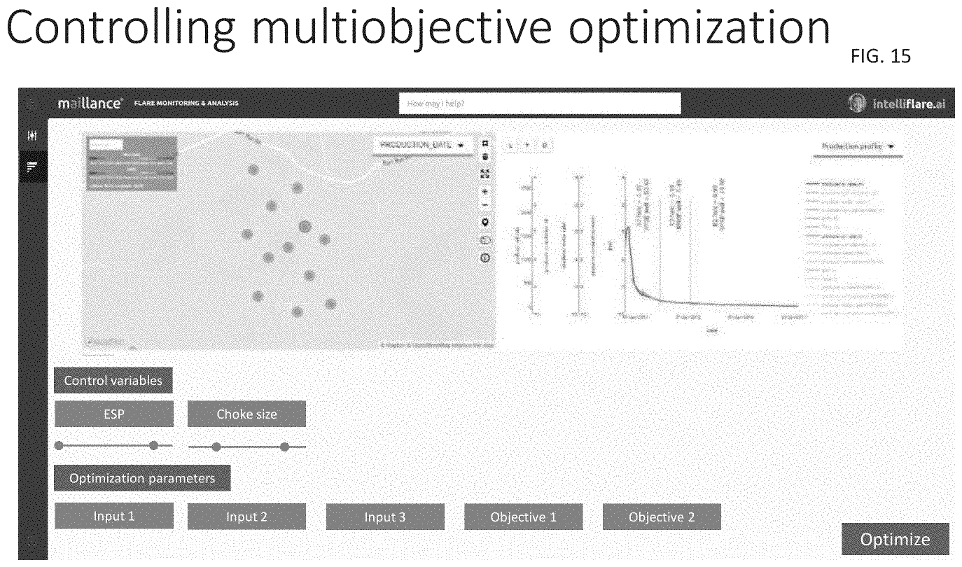

Users can define objective functions and select the optimization algorithm type and parameters using a graphical user interface (see, e.g., FIG. 15). The optimization problem includes a set of objectives (multi objective) and constraints. Constraints are limits on the possible feasible configurations. In other words, the constraints limit which configurations are feasible configurations. Users also can define and import new objective function definitions if the specific objective function is not already provided in system library. For example, the optimization may involve adjusting flow rate of feed to separator or separator pressure in order to change the composition of the flare gas and to minimize carbon emissions and environmental pollution produced by flaring. Another desired outcome may include adjusting the composition in such a way that it minimizes the corrosion of pipelines.

In one or more embodiments, an optimization algorithm aims to find a single best or set of best solutions from the set of all feasible solutions. In other words, a solution is a particular value for each control variable representing a configurable element. Users can specify if they wish to perform an interactive optimization and if they would like to import a new optimization algorithm which is not present in system's library. Evolutionary algorithms are an attractive option for solving multi-objective optimization problems as they work with a population of solutions and can provide an ensemble of Pareto optimal solutions for decision making purposes. These algorithms themselves are divided to two groups of non-elitist based methods and elitist-based algorithms. The first group does not offer a mechanism to systematically preserve the elite solutions in each generation. Examples of non-elitist based approaches include Multi-objective Genetic Algorithm (MOGA) and Nondominated Sorting Genetic Algorithm (NSGA). On the other hand, elitist based approaches tend to favor survival of the elite solutions of each generation to the next one. Some of the algorithms belonging to this group include Pareto-Archived Evolutionary Strategy (PAES), elitist-based NSGA-II algorithm, estimation of distribution algorithms and particle swarm optimization. In one embodiment, the algorithm in this disclosure for multi-objective optimization of flare management is Multi-objective Differential Evolution.

The system shows the optimization progress using several metrics including iteration numbers, current iteration's best objective function values, overall best objective functions and so on. Furthermore, in multi-objective optimization, solution diversity and Pareto optimal coverage is also important and is displayed here.

Users may have an interactive optimization experience where the decision maker interacts with the multi-objective optimization algorithm by providing feedbacks while the optimization is still in progress. As an example, a method can be an interactive multi-objective particle swarm optimization introduced by Hettenhausen et al. (2010). Other methods of interactive optimization that can be utilized include trade-off based algorithms, reference point approaches and classification-based methods.

FIG. 5B is a graph showing one example of a Pareto multi-objective analysis in which the objectives include simultaneously reducing/minimizing flaring and increasing/maximizing oil production. The graph shows an initial population of solutions, an intermediate, mid-way progress and a final population of solutions dispersed along a Pareto front.

### Results Module

The results module 250 is a central decision-making location where the results of running optimization module is displayed to the user. A decision to adjust production and flaring operations such as flow rate can be made by the user and transferred back to field using communication module 260. In yet another embodiment, an automated decision to adjust operational properties is made by optimization module 240 and its results 560; and then transferred to field automatically using communication module 260. Example control parameters for upstream operations include ESP parameters such as VFD and choke size. Example control parameters for midstream include separator pressure.

In one or more embodiments and at various stages of the method, the system may interact with the user through the user interface to obtain additional information including new decision variables, modification of objective function, introduction of new metric to consider in solving the optimization problem, new stopping criteria for the optimization algorithm, new probability distribution, and so on.

FIG. 15 shows an embodiment of a user interface showing outputs provided to a user. In this particular embodiment, for example, the user interface provides well identification (e.g., via a map) and upstream and midstream optimization. The user interface also provides a plurality of user selectable variables (e.g., ESP and choke size) that may be used in an improvement/optimization process. The user interface also provides a plurality of improvement/optimization parameters that may be used in the process. Users will see the oil and gas production profiles generated by the digital twin ML model of the subsurface when the optimization cycle is finished.

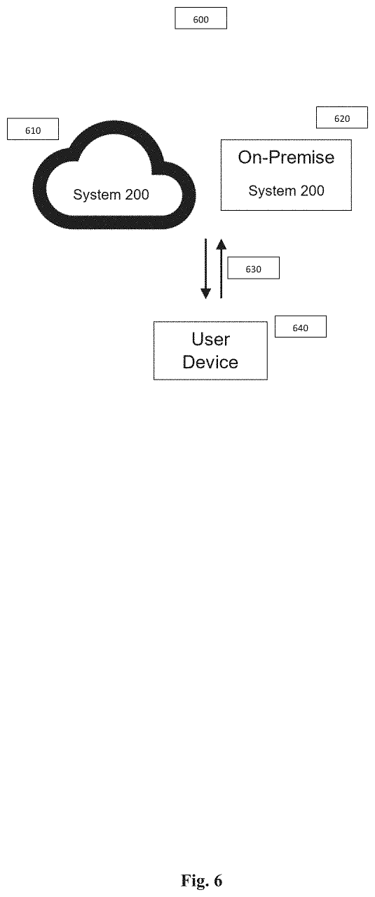

Further, as shown in FIG. 6, one or more elements of the aforementioned computing and storage system 200 may be located at a remote location and connected to the other elements over a network 630 as a cloud computing environment 610 or as on-premise solutions 620. User devices 640 can connect to the system in order to provide requests and receive the transmitted results. The service can be performed as a software as a service (SaaS), platform as a service (PaaS), infrastructure as a service (IaaS) or a combination of these options. The network 630 can be a local area network (LAN), a wide area network (WAN) such as the Internet, mobile network, or any other type of network. Further, embodiments may be implemented on a distributed system having a plurality of nodes, where each portion may be located on a different node within the distributed system. In one embodiment, the node corresponds to a distinct computing device. The node may correspond to a computer storage, processor, micro-core of a computer processor with shared memory and/or resource.

FIG. 7 is a conceptual block diagram 700 illustrating another embodiment of a flare monitoring and optimization system. In FIG. 7, oil and gas is produced from subsurface reservoirs 710 and is transported using pipelines 720 to a surface treatment facility 730 that separates a multiphase flow (e.g. oil, gas, water). The excess gas from surface treatment facilities then might be sent to a flaring stack 740 for burning. In one embodiment, a camera 760 is placed to view the flare 750 and provide continuous image and video of flare as an input to the system. In another embodiment, a user may take a photo and/or video using a mobile phone, tablet, and a similar apparatus. Multimedia capture system is collectively known as input module where images and/or videos captured by camera are received and processed for storage and prediction purposes. In yet another embodiment, upon recognition of gas composition based on multimedia analysis and machine learning, a new fluid flowrate to optimize flaring operation is identified and transmitted to one or more flow control valves 770 to adjust the rate to a newly determined value.

FIG. 7 further shows gas separated from the flow, such as at the surface treatment facility 730, being diverted to a gas turbine 780. The gas turbine 780 burns the gas to provide an output of electrical energy. That electric energy may be provided to support operations at the wellsite, surface treatment facility, monitoring systems, or the like 790 (e.g., well site SCADA and flow computers, control systems operating flow operations such as valves, pumps, and the like) and/or to other processes 795 (e.g., computers for storage such as a server farm or computers adapted to provide crypto mining, or other energy intensive computing processes).

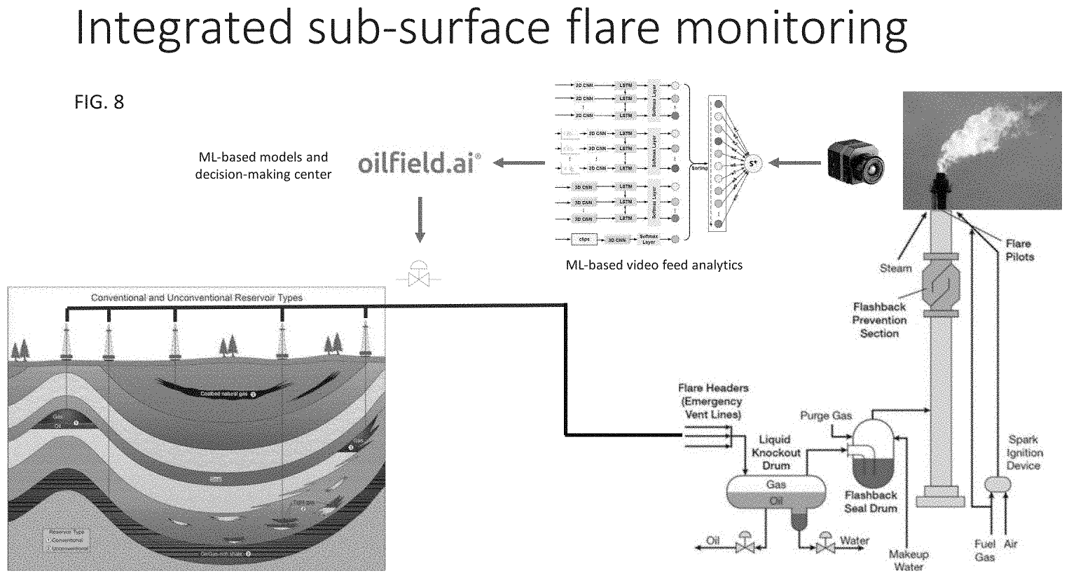

FIG. 8 is a conceptual block diagram 800 illustrating another embodiment of a flare monitoring and optimization system in which a machine learning analytics system is provided to control one or more operation of a pipeline based on one or more output of the monitoring system. In the embodiment shown in FIG. 8, for example, the machine learning analytics system receives the output from the results module (described above with reference to FIG. 2) and controls one or more operations, such as but not limited to one or more pumps 870, to control the mixture of oil and gas (e.g., on a well-by-well basis) provided from the subsurface reservoirs 810 to the surface treatment facility 830 FIG. 7 by the pipelines 820. The surface treatment facility 830 separates a the multiphase flow (e.g. oil, gas, water), and the excess gas from surface treatment facilities then might be sent to a flaring stack 840 for burning. In one embodiment, a camera 860 is placed to view the flare 850 and provide continuous image and video of flare as an input to the system. In another embodiment, a user may take a photo and/or video using a mobile phone, tablet, and a similar apparatus. Multimedia capture system is collectively known as input module where images and/or videos captured by camera are received and processed for storage and prediction purposes.

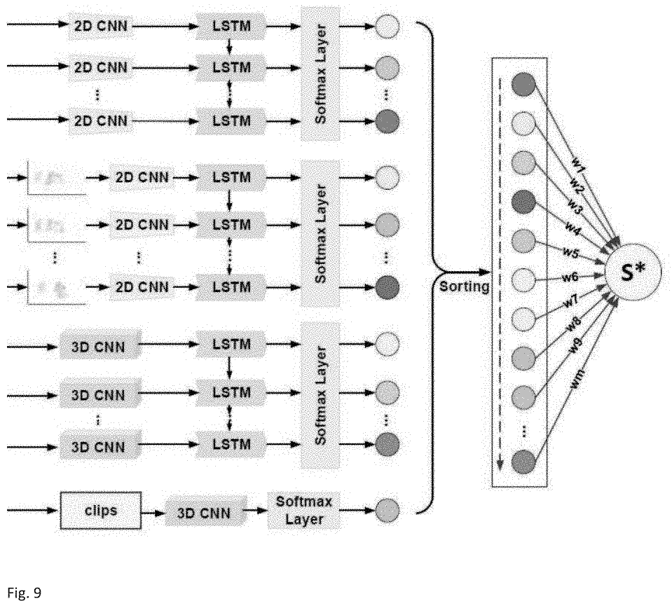

FIG. 9 is a schematic diagram showing an example embodiment of a machine learning analytics system 900, such as described with reference to FIG. 8. In this embodiment, the machine learning analytics system 900 comprises a plurality of two-dimensional (2D) CNN networks and a plurality of three-dimensional CNN networks. The 2D and 3D CNN networks receive image date from the visual recognition and recording system, such as but not limited to a camera, a hyper-spectral camera, or multi-spectral camera as described above with respect to FIGS. 1 and 2). Outputs of the 2D and 3D CNN networks are each provided to corresponding long short-term memory (LSTM) networks (or other recurrent networks) that provide machine learning of long term dependencies from the data received from the CNN networks and provide an output to one of a plurality of Softmax Layers. For each ground-truth value, the cross-entropy loss can be reduced/minimized over the softmax output.

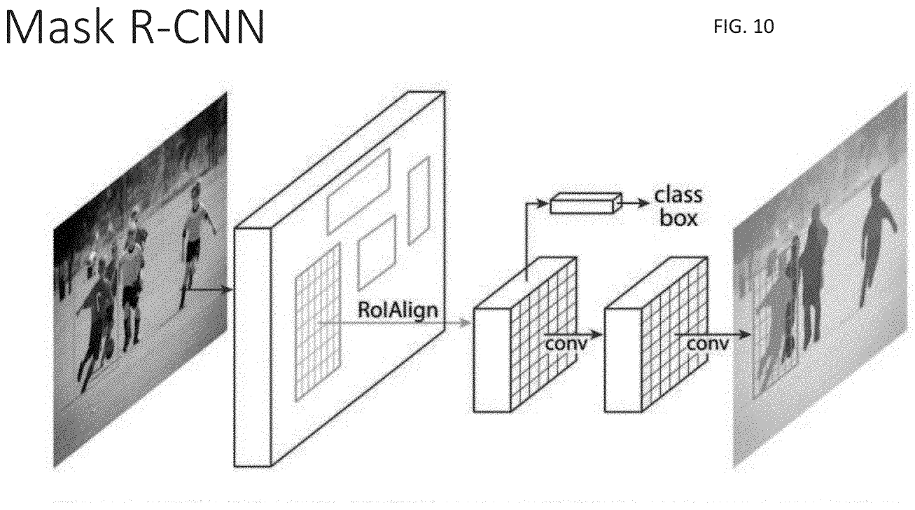

FIG. 10 is a schematic diagram of an embodiment of a Mask R-CNN framework for instance segmentation. The framework, for example, can be used to segment portions of a flare image to assist in identifying the components of the flare. The algorithm first generates proposals about the areas where a flame is expected based on the input image or video. Second, the algorithm predicts the class of the object, such as flame output of burning a gas with heavy carbon components, vs light components. It also refines the bounding boxes and generates a mask in pixel level of the flare based on the first stage proposal.

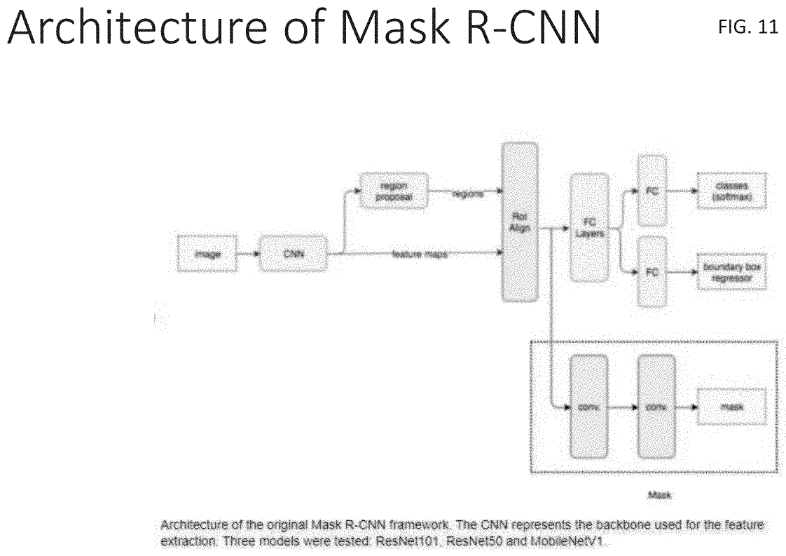

FIG. 11 is a schematic diagram of the Mask R-CNN framework shown in FIG. 10. The algorithm is used for instance segmentation in the flare computer vision system. The algorithm outputs pixel-level flare bonding boxes and boundaries, classes, and masks. It provides of a bottom-up pathway such as ResNet, a top-bottom pathway to generate the feature pyramid map, and lateral connections that are convolutions and add operations between two corresponding levels of the two pathways.

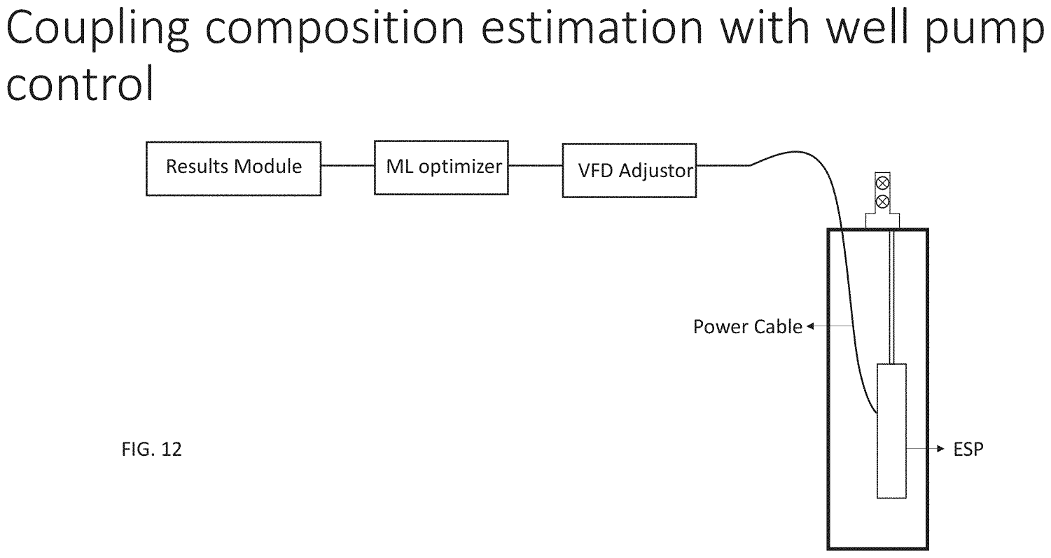

FIG. 12 is a block diagram showing an embodiment of an upstream control system. In this particular embodiment, for example, a pump (or other well device(s)) may be controlled in a process to modify a flare and/or gas component used to fuel a turbine. The upstream control system comprises a controller, such as the VFD adjustor shown, adapted to control one or more operation of a well, such as the ESP via the power cable shown. In this embodiment, the production wells may be equipped with an electric submersible pump (ESP). As described above, an ESP is a type of pump that is enclosed in a protective housing that enables it to be submerged in the fluid that will be pumped. An electric motor drives the pump and can be controlled with a variable frequency drive (VFD) module. The higher VFD values result in faster motor rotates. One example of using the composition estimation is to control the ESP by adjusting the VFD values of the pump. To achieve this objective, the results module (250) is coupled with a secondary machine-learning based optimization module. This module uses the relationship between input parameters such as geological structure of the reservoir, location and pattern of production and injection wells, rock and fluid properties of reservoir, and pump parameters including VFD values to estimate the oil and gas production as its output parameter. Therefore, once a model is trained using historical field data, it can be used to estimate the amount of oil and gas that can be produced at any given VFD setting. Once the gas composition is estimated, it is used by the ML optimizer to find an improved/optimal VFD value, and corresponding rotation speed so that an increased and/or optimal amount of oil is produced from a well. This increased and/or optimal oil production helps to improve and/or optimize the flaring operations in such a way that flaring is reduced and/or minimized and/or combustion efficiency is increased.

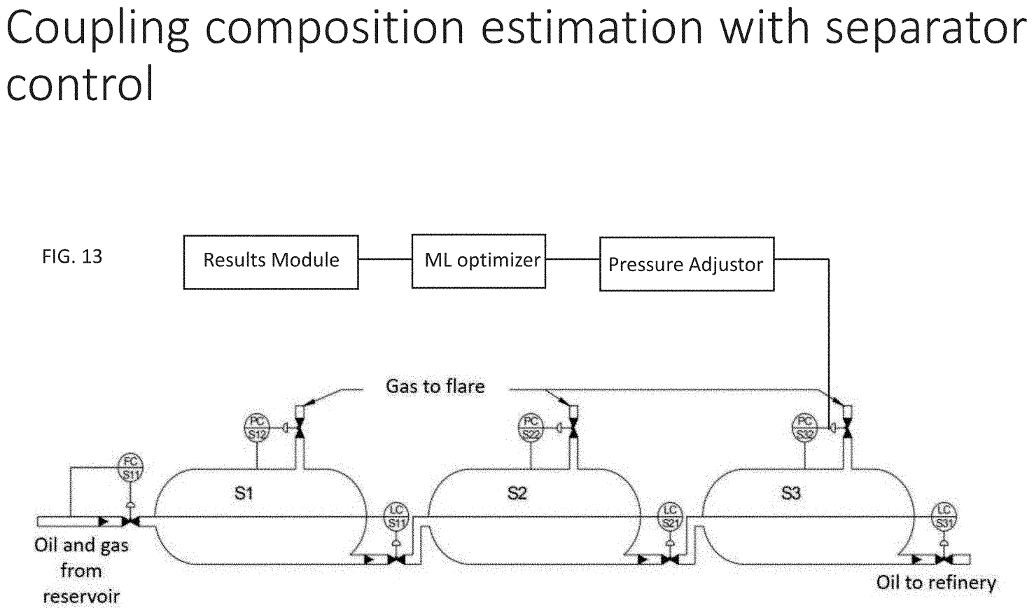

FIG. 13 is a block diagram showing an embodiment of a midstream control system. In this embodiment, for example, a pressure adjustor is provided to control one or more pressure in a midstream separator operation. In this embodiment, the system can adjust a multi-stage separator's pressure (130) in an adaptive fashion in real-time to adjust and/or optimize the flaring gas amount based on an output/control received from the results module and/the ML optimizer. As described above, separators work on the principle that oil, water, and gas have different densities and therefore these fluids can be separated into gaseous and liquid components. The pressure is controlled using valves located on the outlet gas flow. For example, the reservoir fluid can be flashed in an initial separator and then a second flash can be performed on the liquid from the first separator. Oil recovery is impacted by the separator pressure and reservoir fluid composition. A machine learning model, such as but not limited to an artificial neural network is used in one embodiment to model the relationship between pressure, molar volume, and temperature for pure components and mixtures. Then, an optimization routine is coupled with the ML model to select a separator pressure that increases and/or maximizes oil production, and/or decreases and/or minimizes gas that will be flared, and/or improve and/or optimize its composition for combustion.

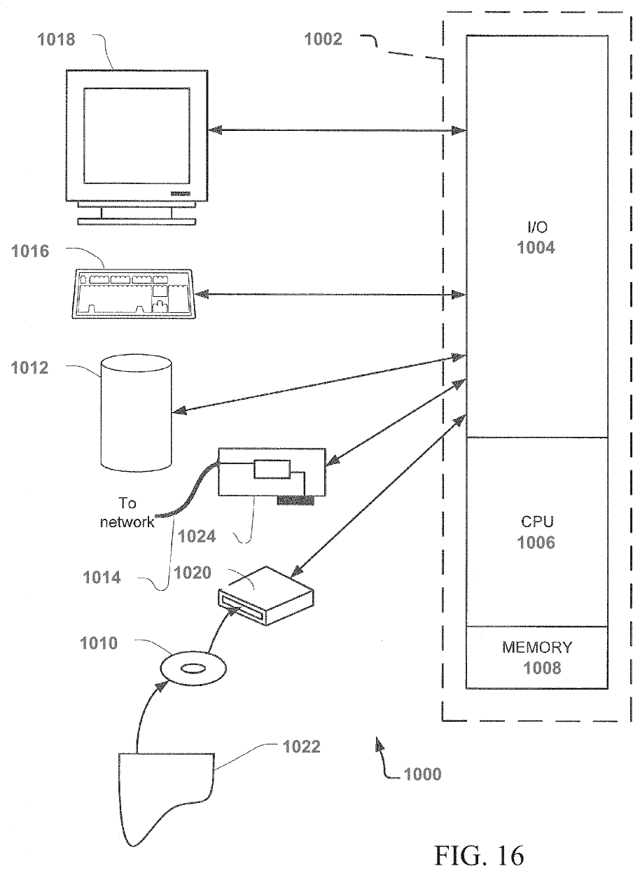

FIG. 16 is a block diagram illustrating illustrates an exemplary system useful in implementations of the described technology. A general purpose computer system 1000, which may be used as the described controller, is capable of executing a computer program product to execute a computer process. Data and program files may be input to the computer system 1000, which reads the files and executes the programs therein. Some of the elements of a general purpose computer system 1000 are shown in FIG. 8 wherein a processor 1002 is shown having an input/output (I/O) section 1004, a Central Processing Unit (CPU) 1006, and a memory section 1008. There may be one or more processors 1002, such that the processor 1002 of the computer system 1000 comprises a single central-processing unit 1006, or a plurality of processing units, commonly referred to as a parallel processing environment. The computer system 1000 may be a conventional computer, a distributed computer, or any other type of computer. The described technology is optionally implemented in software devices loaded in memory 1008, stored on a configured DVD/CD-ROM 1010 or storage unit 1012, and/or communicated via a wired or wireless network link 1014 on a carrier signal, thereby transforming the computer system 1000 in FIG. 8 into a special purpose machine for implementing the described operations.

The I/O section 1004 is connected to one or more user-interface devices (e.g., a keyboard 1016 and a display unit 1018), a disk storage unit 1012, and a disk drive unit 1020. Generally, in contemporary systems, the disk drive unit 1020 is a DVD/CD-ROM drive unit capable of reading the DVD/CD-ROM medium 1010, which typically contains programs and data 1022. The data may be stored in any applicable format and may, in some implementations, stored in an accessible database that is adapted to link items to activities such as uses, procedures, storage, age, etc. In other implementations, the disk drive may be an external storage system such as a standalone database (e.g., located on one or more networked servers). Computer program products containing mechanisms to effectuate the systems and methods in accordance with the described technology may reside in the memory section 1008, on a disk storage unit 1012, or on the DVD/CD-ROM medium 1010 of such a system 1000. Alternatively, a disk drive unit 1020 may be replaced or supplemented by a floppy drive unit, a tape drive unit, or other storage medium drive unit. The network adapter 1024 is capable of connecting the computer system to a network via the network link 1014, through which the computer system can receive instructions and data embodied in a carrier wave. Examples of such systems include SPARC systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 1000 is connected (by wired connection or wirelessly) to a local network through the network interface or adapter 1024, which is one type of communications device. When used in a WAN-networking environment, the computer system 1000 typically includes a modem, a network adapter, or any other type of communications device for establishing communications over the wide area network. In a networked environment, program modules depicted relative to the computer system 1000 or portions thereof, may be stored in a remote memory storage device. It is appreciated that the network connections shown are exemplary and other means of and communications devices for establishing a communications link between the computers may be used.

In accordance with an implementation, software instructions and data directed toward operating the subsystems may reside on the disk storage unit 1012, disk drive unit 1020 or other storage medium units coupled to the computer system. Said software instructions may also be executed by CPU 1006.

The implementations described herein are implemented as logical steps in one or more computer systems. The logical operations are implemented (1) as a sequence of processor-implemented steps executing in one or more computer systems and (2) as interconnected machine or circuit modules within one or more computer systems. The implementation is a matter of choice, dependent on the performance requirements of a particular computer system. Accordingly, the logical operations making up the embodiments and/or implementations described herein are referred to variously as operations, steps, objects, or modules. Furthermore, it should be understood that logical operations may be performed in any order, unless explicitly claimed otherwise or a specific order is inherently necessitated by the claim language.

Furthermore, certain operations in the methods described above must naturally precede others for the described method to function as described. However, the described methods are not limited to the order of operations described if such order sequence does not alter the functionality of the method. That is, it is recognized that some operations may be performed before or after other operations without departing from the scope and spirit of the claims.

Although implementations have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

1. A method for adjusting a composition of an oil and gas flow, the method comprising:
capturing at least one of image and video data of a flare via a camera;
analyzing the at least one of image and video data using a processor to determine properties of gas in the flare; and
controlling at least one of an upstream or midstream operation on the oil and gas flow to modify the composition of the oil and gas flow based on the properties in the flare.

2. The method of claim 1 wherein the camera comprises at least one of a hyper-spectral and a multi-spectral camera.

3. The method of claim 1 wherein operation of analyzing is performed via one or more machine learning routines to learn from prior flaring images and videos.

4. The method of claim 3 wherein the machine learning routine comprises one or more optimization instructions for finding an improved production design or operation parameters that, when executed, produces a ranking of each scenario and its respective effect on flare type, temperature, condition and composition.

5. The method of claim 3 wherein the machine learning routine comprises at least one Convolutional Neural Network (CNN).

6. The method of claim 1 wherein the operation of analyzing is performed to provide estimates of type, temperature and composition of the flare.

7. The method of claim 1 wherein the operation of controlling is performed based on an optimization routine to determine at least one parameter to adjust.

8. The method of claim 7 wherein the optimization routine is based upon at least two competing objectives.

9. The method of claim 5 wherein the at least one parameter comprises a parameter selected from the group comprising an upstream production operation, a midstream processing facility, and a flare stack.

10. The method of claim 1 wherein the operation of controlling comprises diverting at least a portion of the oil and gas flow to a turbine.

11. The method of claim 7 wherein the turbine produces power for at least one of an upstream operation, a midstream operation, and an unrelated load.

12. A system for adjusting a composition of an oil and gas flow, the system comprising:
a camera adapted to capture at least one of image and video data of a flare;
a processor in communication with the camera and adapted to receive the at least one of image and video data and analyze analyzing the at least one of image and video data to determine properties of gas in the flare; and
a controller in communication with the processor and adapted to control at least one of an upstream or midstream operation on the oil and gas flow to modify the composition of the oil and gas flow based on the properties in the flare.

13. The system of claim 12 wherein the camera comprises at least one of a hyper-spectral and a multi-spectral camera.

14. The system of claim 12 wherein the processor is adapted to analyze the at least one of image and video data via one or more machine learning routines to learn from prior flaring images and videos.

15. The system of claim 14 wherein the machine learning routine comprises one or more optimization instructions for finding an improved production design or operation parameters that, when executed, produces a ranking of each scenario and its respective effect on flare type, temperature, condition and composition.

16. The system of claim 14 wherein the machine learning routine comprises at least one Convolutional Neural Network (CNN).

17. The system of claim 12 wherein the processor is adapted to analyze the at least one of image and video data to provide estimates of type, temperature and composition of the flare.

18. The system of claim 12 wherein the controller is adapted to control the operation based on an optimization routine to determine at least one parameter to adjust.

19. The system of claim 18 wherein the optimization routine is based upon at least two competing objectives.

20. The system of claim 16 wherein the at least one parameter comprises a parameter selected from the group comprising an upstream production operation, a midstream processing facility, and a flare stack.

21. The system of claim 12 wherein the controller is adapted to control the operation to divert at least a portion of the oil and gas flow to a turbine.

22. The system of claim 18 wherein the turbine produces power for at least one of an upstream operation, a midstream operation, and an unrelated load.
